(19) United States
(12) Patent Application Publication
(10) Pub. No.: US 2008/0061234 A1
(43) Pub. Date: Mar. 13, 2008

(54) Inspection apparatus and method

(75) Inventor: Toyokazu Nakamura, Kawasaki (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KAWASAKI (JP)

(21) Appl. No.: 11/798,093

(22) Filed: May 10, 2007

(30) Foreign Application Priority Data
May 16, 2006 (JP) 2006-136643

(51) Int. Cl. G01N 23/223; G01J 1/42; G01N 23/225

(52) U.S. Cl. 250/310; 250/336.1; 250/393; 378/22; 378/44

(57) ABSTRACT

Provided is an apparatus for acquiring information about the interior of a sample non-destructively and with high resolution, determining pass/fail of the sample and shortening inspection time. A sample is irradiated with an electron beam or X-rays, fluorescent X-rays from the sample are converted using a zone plate and are detected by a detector, an electric signal from the detector is converted to a digital signal by an A/D converter and the digital signal is applied to a fail decision unit, which determines pass/fail of the sample. If the sample is fail, an image processor applies image processing and presents a display on an image display unit.

### FIELD OF THE INVENTION

This invention relates to an inspection technique and, more particularly, to an inspection apparatus and method ideal for application to non-destructive and non-contact defect inspection of semiconductor devices.

### BACKGROUND OF THE INVENTION

An example of a non-destructive and non-contact inspection apparatus of this kind is disclosed in Patent Document 1. The disclosed apparatus includes means for irradiating a sample (a semiconductor device) with an electron beam and detecting the intensity of characteristic X-rays dependent upon the amount of a specific substance present at the position irradiated with the electron beam, and monitor means for monitoring the X-ray intensity detected. The apparatus further includes decision means for deciding failure based upon the value of X-ray intensity detected. When failure has been decided by the monitor means, the location of the defect is displayed on a display unit. According to the apparatus and method disclosed in Patent Document 1, the characteristic X-ray intensity of a wiring material (A1) at each scanned location is displayed in the form of a grayscale image utilizing the fact that the characteristic X-ray intensity of material (A1) in a wiring area filled properly with the material (A1) in the form of a via hole differs from the characteristic X-ray intensity of a defective via hole ascribable to voids or residual oxide film, etc. This makes it possible to determine pass/fail of a via hole. In Patent Document 1, the irradiation width of the electron beam is on the order of 1.0 μm.

FIG. 2 is a diagram illustrating an example of the configuration of a conventional inspection apparatus disclosed in Patent Document 1, etc. As shown in FIG. 2, a finely narrowed electron beam 13 from an electron gun 2 irradiates a DUT (Device Under Test) 3, fluorescent X-rays 10 from the irradiated region are detected by a detector 5, an electric signal (an analog signal) from the detector 5 is converted to a digital signal by an A/D converter 6, and the digital signal is sent to a fail decision unit 7. The fail decision unit 7 determines pass/fail of the DUT 3. If the DUT 3 is judged to be fail, then the location of the defect is displayed on an image display unit 9 through an image processor 8. The image processor 8 executes prescribed image processing upon receiving input of a digital value of characteristic X-ray intensity at each scanned location from the A/D converter 6, input of fail information from the fail decision unit 7 and input of information (a drive signal applied to a sample stage 4), which indicates the location of the DUT 3 irradiated with the electron beam 13, from the sample stage 4 of an SEM (Scanning Electron Microscope) 1.

With the configuration of FIG. 2, the fine electron beam 13 (of weak intensity) is used in order to obtain a high resolution. In cases where scanning is performed with regard to a surface or line, it is required that processing be executed while performing sequential scanning. This lengthens scanning time.

Patent Document 2 discloses an example of a technique for measuring a secondary electron beam from a sample. Specifically, in the inspection of patterns on a wafer for the presence of faults, foreign matter, residue and differences in level, the disclosed high-resolution defect inspection apparatus for implementing the inspection at high speed forms an electric field, which is for decelerating an electron beam, on the surface of a semiconductor under inspection, forms an image by an imaging lens by causing the electron beam (a sheet electron beam), which has a fixed area and contains a component of energy that is incapable of reaching the surface of the semiconductor owing to the decelerating electric field, to be reflected very near the surface of the semiconductor, acquires images of a plurality of areas on the surface of the semiconductor, stores these images in an image memory and compares the stored images of the plurality of areas, thereby determining whether or not defects exist in these areas as well as the positions of any defects.

Non-Patent Document 1 discloses a technique for similarly performing area-irradiation of electron beams and measuring a secondary electron beam. Specifically, the disclosed inspection apparatus irradiates a comparatively wide area with a sheet electron beam and forms the image of a secondary X signal from this area on detectors arrayed in two dimensions, whereby imaging is performed collectively.

In a case where a sample is irradiated with a primary X-ray, secondary X-rays (fluorescent X-rays) having a wavelength specific to the elements contained in the sample are produced from the sample and the fluorescent X-rays produced are subjected to spectrographic analysis and intensity measurement, thereby making qualitative analysis and quantitative analysis possible. For this reason, fluorescent X-ray analysis has long been applied to various analytical and inspection systems. For example, Patent Document 3 discloses a method in which when a sample is irradiated with an electron beam, irradiation is performed using an X-ray microbeam and fluorescent X-rays from the sample are analyzed, thereby making it possible to obtain a profile of the concentrations of an observed element at a resolution of less then one micron.

Further, Xradia's nanoXFi™, etc., is known as an apparatus that forms an image of fluorescent X-rays by a high-resolution zone plate lens, thereby providing images of sample surfaces and sub-surfaces (see Non-Patent Document 2). This X-ray imager provides a map of copper interconnection and images of voids and shorts with a spatial resolution of 80 nm. Further, Xradia's nanoXCT™ (see Non-Patent Document 3) states that a 3D tomographic image of interconnection inclusive of copper pads, interconnection and W heat sinks is obtained using a solid model, etc. In applications of multi-Kev and higher-energy X-ray imaging and image formation, it has become possible to manufacture a high-performance zone plate lens in relation to spatial resolution and efficiency of image formation.

Furthermore, as an application to a method of obtaining two- and three-dimensional distributions of the chemical state of the microarea of a sample in X-ray image forming technology using a zone plate and in a fluorescent X-ray analysis method of performing element analysis by emitting an X-ray microbeam and analyzing fluorescent X-rays released from a sample surface or interior, Patent Document 4, for example, discloses an optical component for focusing X-rays on the order of 10 to 100 Kev, the optical part having a solder layer in which a zone plate has been embedded and a support base, wherein an adhesive layer is provided between the solder layer and the support base and an adhesive layer is not provided between the zone plate and the support base. Also disclosed are an X-ray microscope, a microfluorescent X-ray analyzing apparatus and a micro X-ray tomography apparatus. A zone plate 111 comprises a plurality of annular bands disposed concentrically on a transparent substrate, every other annular band being opaque and has a lens function in which light (X-rays) from a transparent body form an image at positive and negative focal points on the optic axis owing to the diffracting action of the annular bands.

Further, Patent Document 4 discloses that when a sample is irradiated with an electron beam, the beam spreads within the sample (on the order of one micron) and the spatial resolution obtained is on the order of one micron. Patent Document 4 discloses a method so adapted that a profile of the concentration of observed elements can be obtained at a resolution of less than one micron by irradiating a sample with an X-ray microbeam and analyzing fluorescent X-rays from the sample.

[Patent Document 1]

Japanese Patent Kokai Publication No. JP-A-10-318949

[Patent Document 2]

Japanese Patent Kokai Publication No. JP-P2005-292157

[Patent Document 3]

Japanese Patent Kokai Publication No. JP-P2003-17539A

[Patent Document 4]

Japanese Patent Kokai Publication No. JP-P2004-145066A

[Non-Patent Document 1]

Tohru Satake & Nobuharu Noji, “Development (First Report) of Wafer Defect Inspection Apparatus (EBeye) Using an Electron Beam—Background of Development and Apparatus Principles (Concept)”, Ebara Review, No. 207, pp. 15-20, 2005 April

[Non-Patent Document 2]

“nanoXFi™ X-ray Fluorescence, Imager”, Xradia Inc. <URL: http://xradia.com/nanoXFIbrochure.pdf>

[Non-Patent Document 3]

“A revolutionary X-ray 3D Imaging Technology for non-destructive failure analysis”, nanoXCT™ REV 2005 Jul. 6 Xradia Inc.

### SUMMARY OF THE DISCLOSURE

With the inspection apparatus of Patent Document 1, it is necessary to narrow down the electron beam in a case where a high resolution is obtained. This lengthens inspection time.

Further, in the case of Non-Patent Document 1 (EBeye), a comparatively wide area is subjected to area-irradiation collectively and the image of a secondary electron beam from this area is formed on detectors arrayed in two dimensions, whereby imaging is performed in collectively. As a result, inspection time is shortened in comparison with the SEM scheme (inspection speed is raised by approximately one order of magnitude with a resolution of 100 nm and by approximately two orders of magnitude with a resolution of 50 nm). However, it is thought that detecting the surface, etc., of an insulator using a secondary electron beam is difficult to perform owing to charge-up, etc.

Accordingly, problems remain in terms of implementing an inspection apparatus, particularly a wafer inspection apparatus, that is capable of delivering higher resolution and higher speed.

The present invention applies an X-ray focusing and image-forming technique using a high-resolution zone plate lens to an inspection apparatus such as a wafer inspection apparatus. Further, the present invention provides a technique for acquiring a two- or three-dimensional image by a fluorescent X-ray microscope that employs a high-resolution zone plate lens.

An inspection apparatus in accordance with an aspect of the present invention comprises: a first X-ray lens for receiving X-rays from a sample under inspection; a detector for detecting X-rays that have passed through the first X-ray lens; and a decision unit that determines pass/fail of the sample based upon result of detection by the detector.

An inspection apparatus in accordance with another aspect of the present invention uses, X-rays as the excitation beams. The apparatus comprises a second X-ray lens, which is inserted between an X-ray source and the sample under inspection, for converging X-rays from the X-ray source.

In an embodiment of the present invention, it may be so arranged that the first and second X-ray lenses construct a confocal optical system in which the focal points coincide. In this case, a pin hole is placed at a confocal point between the first X-ray lens and the detector to thereby obstruct X-rays other than those having the spot diameter of the focal point. As a result, the corresponding relationship between the X-ray irradiation spot and the intensity of the fluorescent X-rays detected by the detector can be made essentially 1:1. That is, in accordance with the embodiment of the present invention, there is provided a confocal fluorescent X-ray microscope apparatus (observation apparatus) comprising a first lens to which are input fluorescent X-rays from a sample under inspection irradiated with an excitation beam; a second lens disposed between an excitation-beam source which outputs the excitation beam and the sample under inspection; and a pin hole disposed between the first lens and a detector; wherein the first and second lenses construct a confocal optical system in which focal points coincide, the pin hole is placed at a confocal point, and the relationship between amount of generated fluorescent X-rays that are output from a spot at a focal-point position irradiated with the excitation beam and fluorescent X-ray intensity of fluorescent X-rays, from the irradiated spot, detected by the detector through the first lens and the pin hole is made essentially 1:1.

A method in accordance with another aspect of the present invention, in which fluorescent X-rays is used, comprises:

detecting fluorescent X-rays from a sample under inspection, the fluorescent X-rays being detected by a detector through a zone plate; and determining pass/fail based upon result of detection by the detector.

The meritorious effects of the present invention are summarized as follows.

In accordance with the present invention, fluorescent X-rays are formed into an image on a detector, whereby information concerning the interior of the sample is acquired non-destructively at high speed and high resolution so that pass/fail can be determined.

Further, in accordance with the present invention, the sample is area-irradiated with an electron beam, thereby making it possible to raise the energy level of the electron beam and the level of the fluorescent X-rays and to improve resolution.

In accordance with the present invention, a tomograph, etc., of a sample can be acquired at a high resolution using a fluorescent X-ray microscope.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a diagram illustrating the configuration of an example of the present invention;

FIG. 2 is a diagram illustrating the configuration of an inspection apparatus according to the conventional art;

FIG. 3 is a diagram illustrating the configuration of an X-ray CT apparatus;

FIG. 4 is a diagram illustrating the configuration of a microfocus X-ray CT apparatus;

FIG. 5 is a diagram illustrating an example of the configuration of a fluorescent X-ray CT microscope apparatus according to an example of the present invention;

FIG. 6 is a diagram illustrating another example of the configuration of a fluorescent X-ray CT microscope apparatus according to an example of the present invention; and

FIG. 7 is a diagram illustrating a further example of the configuration of a fluorescent X-ray microscope apparatus according to an example of the present invention.

### EXAMPLES OF THE INVENTION

The present invention will be described in detail with reference to the accompanying drawings.

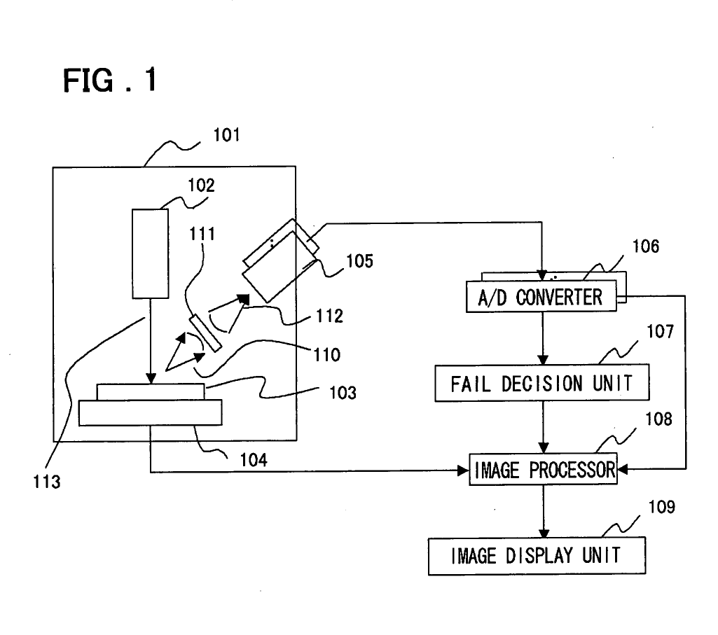

FIG. 1 is a diagram illustrating the configuration of an example of the present invention. As shown in FIG. 1, a sample (DUT) (103) under inspection is area-irradiated with an excitation beam. X-rays (110) from the sample (103) are converged by a high-resolution X-ray lens (zone plate) (111) and an image is formed on a detector (105). The detection signal from the detector (105) is converted to a digital signal by an A/D converter (106) and pass/fail is decided by a fail decision unit (107). If a fail is found, image processing is executed by an image processor (108) and the processed image is displayed on an image display unit (109). According to the present invention, the sample (103) is area-irradiated with an electron beam serving as the excitation beam. X-rays (110) from the sample are fluorescent X-rays from the area of the sample that have been area-irradiated with the electron beam. Further, the present invention provides a technique for acquiring a two- or three-dimensional image by a fluorescent X-ray microscope using a high-resolution zone plate lens, and displaying an image of a two- or three-dimensional concentration profile of the material (elements, etc.). Examples in which the present invention is applied to the inspection of the insulating film of a semiconductor device will be described below.

As shown in FIG. 1, an electron gun 102 performs area-irradiation with an electron beam 113 in this example.

In this example, a DUT (Device Under Test) 103 is area-irradiated with the electron beam 113 in the form of an area beam having a two-dimensionally spread and a preferred spot size of greater than 4 μm or up to about 100 μm. The location area-irradiated with the electron beam 113 is sequentially scanned by the beam by moving a stage 104.

In this example, fluorescent X-rays are emitted from the area-irradiated region of an insulating film of a semiconductor wafer constituting the DUT 103, characteristic X-rays of the insulating film of interest from the fluorescent X-rays are converged using a zone plate 111, and the image of fluorescent X-rays 112 for imaging is formed on a detector 105. The detector 105 senses the formed image in the form of a line or area.

If the insulating film of the semiconductor wafer constituting the DUT 103 has a void or scratch, the intensity of the characteristic X-rays at this portion differs from that at normal portions (the intensity decreases) and luminance, for example, declines. On the captured image, a void or scratch will appear at the portion of reduced amount of characteristic X-rays.

The electric signal from the detector 105 (the electric signal corresponds to the intensity of the characteristic X-rays) is converted to a digital signal by the A/D converter 106, and the fail decision unit 107 discriminates pass/fail based upon this digital signal. This information is subjected to image processing by the image processor 108 and fail portions are displayed on the image display unit 109. The image processor 108 executes prescribed image processing upon receiving the digital value of characteristic X-ray intensity at each scanned position from the A/D converter 106, fail information from the fail decision unit 107, and information representing the position on the DUT 103 irradiated by the electron beam 113 from the sample stage 104 (the drive signal of the sample stage 104) of SEM 101.

In this example, the image of the characteristic X-rays from the area area-irradiated with the electron beam is formed on the detector 105 via the zone plate 111. The detector 105 preferably comprises multi-channel detectors. In this case, the A/D converter 106 also comprises multiple A/D converters arranged to correspond to the multi-channel detectors. The multiple A/D converters receive respective detection signals (electric signals) on channels corresponding to line- or area-shaped areas from the multi-channel detectors and convert these signals to respective ones of parallel digital signals. As a result, processing is speeded up. It should be noted that any well-known arrangements can be used as the multi-channel detectors and multiple A/D converters.

In accordance with this example, the image of a material including a transparent film such as glass can be obtained with a high spatial resolution of 30 nm, by way of example.

Further, in accordance with this example, not only is it possible to observe the surface of an insulating film and detect scratches, holes, chips and fails, but it is also possible to analyze, two or three dimensionally, a profile of density (concentration) of elements in the insulating film.

Furthermore, in accordance with this example, it is possible to speed up the visualization and fail detection of two- and three-dimensional structures such as copper and aluminum metal interconnection. In the case of three-dimensional analysis, it may be so arranged that fluorescent X-ray intensity information is stored in correspondence with flying distance of the electron beam within the sample and a profile in the depth direction (resolution in the depth direction is, e.g., approximately 2 μm, and resolution in a plane is, e.g., approximately 30 nm) is created.

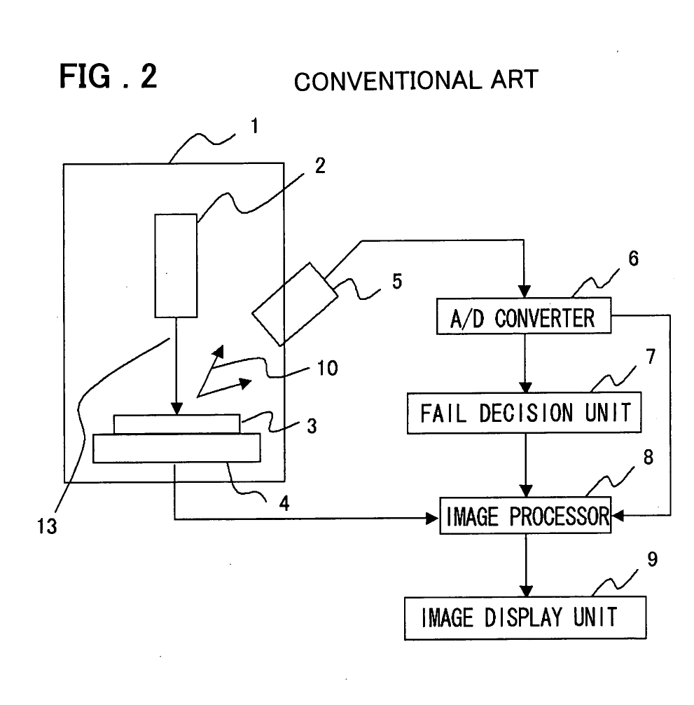

In accordance with this example, a high-resolution material map (or element profile) is not obtained by reducing the diameter of the electron beam, as in the arrangement shown in FIG. 2. Rather, images of fluorescent X-rays from a wide area are formed on a detector collectively using the zone plate 111. Resolution depends upon the numerical aperture (NA) of the zone plate. For example, in a case where Xradia's zone plate is used, a resolution (spatial resolution) of 30 nm is obtained. Although not illustrated, it goes without saying that it may be so arranged that the distance between the zone plate and the sample is controlled so as to vary and images of the characteristic X-rays of two different elements are formed separately on respective ones of detectors.

Further, in accordance with this example, the intensity of the electron beam can be increased because use is made of a thick electron beam (e.g., a spot size of greater than 4 μm or up to about 100 μm). With a finely narrowed electron beam, on the other hand, the intensity of the electron beam cannot be increased because of the repulsive force between electrons. Consequently, the characteristic X-rays are of weak intensity and measurement time is prolonged.

In this example, characteristic X-rays corresponding to an irradiated region are supplied to multiple detectors collectively and a plurality of spot signals are processed in parallel. As a result, measurement time is shortened and speed is raised by more than one order of magnitude in comparison with the conventional art example of FIG. 2.

It should be noted that in the present invention, X-rays may be used instead of an electron gun as a line source for excitation of fluorescent X-rays. In this case, penetrating X-rays can also be measured, as in X-ray CT (computed tomography), in addition to fluorescent X-rays.

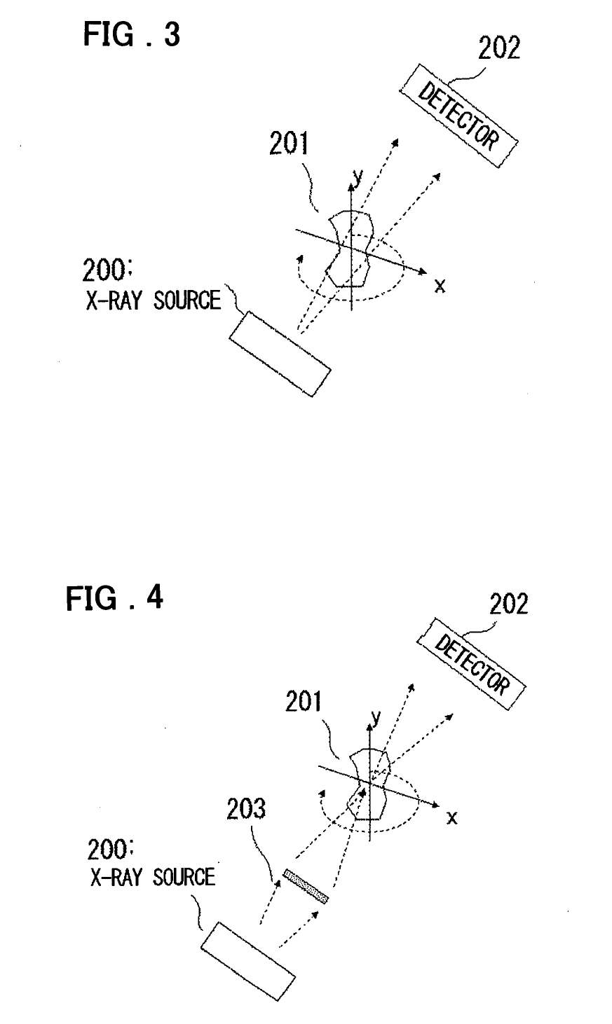

An X-ray CT apparatus that detects penetrating X-rays will be described. FIG. 3 is a schematic view useful in describing a typical example of tomography using X-rays (so-called X-ray CT). The intensity of penetrating X-rays detected by a detector 202 corresponds to the integrated value of absorptivity μ along the path of X-ray transmission [where I=I₀exp(−μd) holds, I represents the intensity of transmitted light, I₀ the intensity of incident light and the thickness]. The X-ray beam is scanned relative to a sample 201 [the sample is rotated about the y axis, where the z axis (not shown) is the optic axis], a secondary X distribution μ(x,y) of absorptivity in the x-y plane is calculated from the intensity of the penetrating X-rays detected by the detector 202, and μ(x,y) is displayed in the form of a grayscale image, whereby an image (CT image) is acquired. The resolution of the CT image is greater than 100 nm. A three-dimensional CT image is obtained by moving the sample 201 in the direction of the z axis (optic axis), by way of example.

FIG. 4 is a diagram schematically illustrating the configuration of a microfocus X-ray CT apparatus. Although there is no particular limitation, an example in which the zone plate (whose spatial resolution is 30 nm) used in the first example above is employed as a lens for converging an X-ray beam will be described. The X-rays from an X-ray source 200 are brought to a focal point (30 nm) in front of the sample 201 using a zone plate 203. A secondary X image of absorptivity μ can be obtained with a high resolution by rotating the sample 201 about the y axis very near the focal point. A three-dimensional CT image is obtained by moving the sample 201 in the direction of the z axis (optic axis), by way of example. It should be noted that the angle of rotation of the sample 201 is not limited to 360° and may be an angle smaller than 360°. In the arrangements of FIGS. 3 and 4, the X-ray intensity detected by the detector 202 corresponds to the integrated value of amount of absorption along the path of X-ray transmission.

In the case of the arrangements shown in FIGS. 3 and 4, the fluorescent X-rays and penetrating X-rays from the sample 201 are not separated. The absorptivity of the X-rays therefore is calculated from the penetrating X-rays the strength of which is an order of magnitude greater in comparison with the fluorescent X-rays.

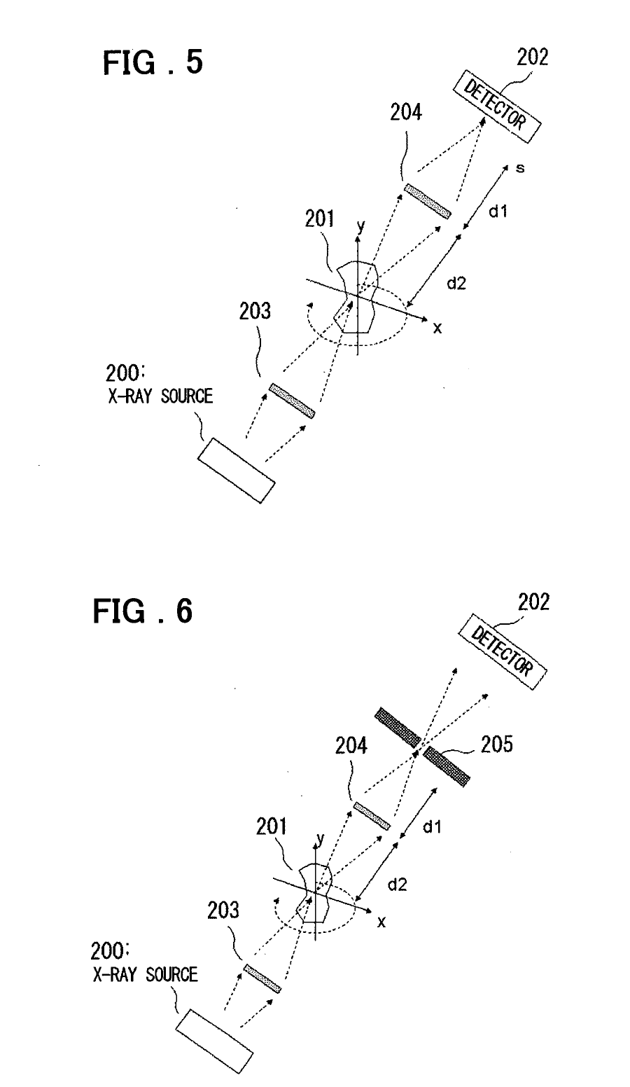

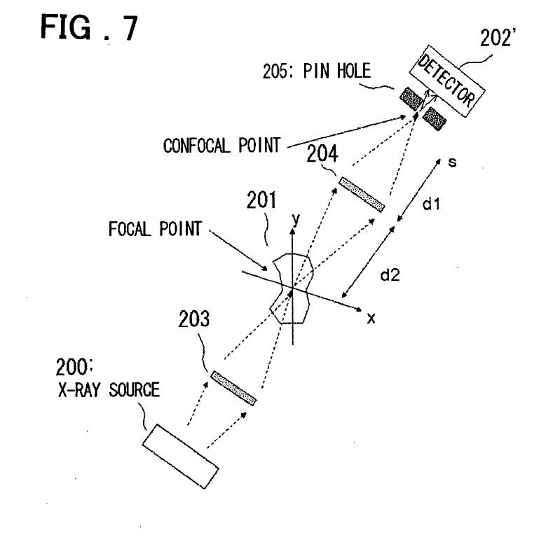

The present invention provides an arrangement for separating fluorescent X-rays from penetrating X-rays and detecting the fluorescent X-rays. FIG. 5 is a schematic view useful in describing a fluorescent X-ray CT microscope constituting a second example of the present invention. In FIG. 5 (and in FIGS. 6 and 7 as well), structural elements from the detector 202 onward, such as the A/D converter, are not shown.

According to this example, as illustrated in FIG. 5, the zone plate (X-ray lens) 203 for converging the X-ray beam to an inspection spot on the sample 201 is provided between the X-ray source 200 and sample 201, and a zone plate (X-ray lens) 204 for converging fluorescent X-rays from the sample 201 and forming an image on the detector 202 is provided between the sample 201 and the detector 202. Selection of the material under inspection, and therefore selection of the wavelength of the fluorescent X-rays from the material, is adjusted based upon d1 (the distance between the zone plate 204 and the detector 202) and d2 (the distance between sample 201 and the zone plate 204). For example, the fluorescent X-rays to be detected can be changed by adjusting the position of the zone plate 204 along the optic axis. In this example, the zone plate 203 has its focal point in front of the sample 201 (e.g., a resolution of 30 nm). The intensity of the fluorescent X-rays detected by the detector 202 corresponds to the integrated value of the amount of generated fluorescent X-rays in relation to the path. A secondary X image of rate (amount) of generation of fluorescent X-rays in the x-y plane is derived by rotating the sample 201 about the y axis and measuring the intensity of the fluorescent X-rays. It should be noted that the angle of rotation of the sample 201 is not limited to 360° and may be an angle smaller than 360°. A three-dimensional CT image is obtained by moving the sample 201 in the direction of, e.g., the z axis (the optic axis).

An electron beam may be used instead of the X-ray source 200 in FIG. 5. In this case, the focal point is placed in front of the sample 201 by an electromagnetic lens (which corresponds to the zone plate 203 in FIG. 5), etc.

Further, in FIG. 5, an example in which the sample 201 is rotated and moved relative to the X-ray source 200 and detector 202 is illustrated. However, it is of course permissible to adopt an arrangement in which X-ray source 200 and detector 202 are scanned relative to the sample 201.

FIG. 6 is a diagram illustrating a modification of the fluorescent X-ray CT microscope shown in FIG. 5. In this modification, as shown in FIG. 6, a pin hole 205 is provided between the zone plate (X-ray lens) 204 and detector 202 of FIG. 5. A projection image of the fluorescent X-rays that have passed through the pin hole 205 (fluorescent X-rays of the selected wavelength) is formed on the detector 202. In the arrangement of FIG. 5, the fluorescent X-rays detected by the detector 202 are selected by adjusting the position of the zone plate 204 on the optic axis. In the arrangement of FIG. 6, however, the fluorescent X-rays detected by the detector 202 are selected by adjusting the position of the pin hole 205 on the optic axis. It should be noted that in the arrangements of FIGS. 5 and 6, the detector 202 is preferably an area detector having a plurality of X-ray receptors.

FIG. 7 illustrates the configuration of a further example of the present invention. As shown in FIG. 7, the zone plates (X-ray lenses) 203 and 204 construct a confocal optical system in which the focal points of the zone plates coincide with each other. The confocal optical system blocks light (background light) having a diameter other than the spot diameter of the focal point. That is, the pin hole 205, which is situated at the position of the “confocal point” in FIG. 7, obstructs X-rays other than X-rays from the focal point in FIG. 7, thereby realizing a high resolution. Selection of the material under inspection (selection of the wavelength of the fluorescent X-rays to be detected) is adjusted based upon d1 (the distance between the zone plate 204 and the pin hole 205) and d2 (the distance between sample 201 and the zone plate 204).

In the case of the arrangement of the confocal optical system shown in FIG. 7, the amount of fluorescent X-rays produced at the X-ray irradiation spot (the position indicated by “FOCAL POINT” in FIG. 7) on the sample 201 is detected by a detector 202′. That is, the intensity of the fluorescent X-rays detected by the detector 202′ is not the integrated value of the amount of generated fluorescent X-rays in relation to the path, as in the case of FIGS. 5 and 6, but is in 1:1 correspondence with the amount of generated fluorescent X-rays at the X-ray irradiation spot (focal point). Accordingly, by scanning the X-ray irradiation spot and detecting the fluorescent X-rays at the confocal point, two- and three-dimensional distribution images (or a profile of concentrations of elements) of amount of generated X-rays corresponding to the scanning position can be obtained directly. That is, there is no need for calculation processing for calculating a profile of fluorescent X-ray generation rate (amount) at each spot from an integrated value of amount of generated fluorescent X-rays in relation to the path, as in the case of FIGS. 5 and 6.

It should be noted that the sample 201 may be rotated about the y axis or scanned along the x axis, y axis and optic axis (z axis). Scanning may be performed on the side of the X-ray beam. Alternatively, an arrangement in which the X-ray beam is deflected using a deflector such as a polygon mirror (not shown) may be adopted. In this case, the position of the sample 201 relative to the X-ray source 200 and detector 202′ is held fixed [i.e., a stage (not shown) is held at a fixed position], the spot irradiated by the X-ray beam is deflected over a prescribed range and the amount of generated fluorescent X-rays corresponding to the irradiation spot is detected by the detector 202′. It should be noted that since the detector 202′ senses the image of the confocal point (pin hole 205) (or light that has passed very close to this point), the detector need not be an area detector (a set of a plurality of photoreceptors) of the kind used in FIGS. 5 and 6. That is, the detector 202′ may be constituted by a single photoreceptor (e.g., a photomultiplier).

Acquisition of an image by the above-described fluorescent X-ray microscope is effective in identifying the structure of a microarea in part of sample, by way of example. That is, by using the arrangement conjointly with the first example in which area-irradiation is performed as described with reference to FIG. 1, an improvement in the efficiency and accuracy of scanning (analysis) can be achieved.

Though the present invention has been described in accordance with the foregoing examples, the invention is not limited to this example and it goes without saying that the invention covers various modifications and changes that would be obvious to those skilled in the art within the scope of the claims.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. An inspection apparatus comprising:
a first X-ray lens that receives X-rays from a sample under inspection;
a detector that detects X-rays which have passed through said first X-ray lens; and
a decision unit that determines pass/fail of the sample based upon result of detection by said detector.

2. The apparatus according to claim 1, further comprising a unit that irradiates the sample with an excitation beam;
wherein said detector detects fluorescent X-rays from the sample through said first X-ray lens.

3. The apparatus according to claim 2, wherein an electron beam is used as the excitation beam, and said apparatus further comprises an electron gun that area-irradiates the sample with the electron beam;
said first X-ray lens forming an image of the fluorescent X-rays from the sample on said detector.

4. The apparatus according to claim 2, wherein an X-ray beam is used as the excitation beam, and said unit comprises an X-ray source and a second X-ray lens that is inserted between the X-ray source and the sample and that converges X-rays from the X-ray source.

5. The apparatus according to claim 4, wherein said first X-ray lens converges X-rays from the sample and forms the image thereof on said detector.

6. The apparatus according to claim 4, further comprising a pin hole provided between said first X-ray lens and said detector.

7. The apparatus according to claim 4, wherein said first and second X-ray lenses construct a confocal optical system in which focal points of said lenses coincide.

8. The apparatus according to claim 7, wherein a pin hole is placed at a confocal point between said first X-ray lens and said detector to thereby obstruct X-rays other than those having the spot diameter of the focal point.

9. The apparatus according to claim 8, wherein the relationship between amount of generated fluorescent X-rays that are output from a spot at a focal-point position irradiated with the X-rays and fluorescent X-ray intensity of fluorescent X-rays, from the irradiated spot, detected by said detector through said first lens and said pin hole is made essentially 1:1.

10. The apparatus according to claim 8, further comprising a deflector for deflecting the irradiating X-rays toward the sample.

11. The apparatus according to claim 4, further comprising a unit that scans the sample relative to the X-rays, thereby constructing a fluorescent X-ray microscope for acquiring a tomograph of the sample using fluorescent X-rays.

12. The apparatus according to claim 4, wherein said first X-ray lens comprises a zone plate.

13. The apparatus according to claim 4, wherein said second X-ray lens comprises a zone plate.

14. The apparatus according to claim 1, further comprising:
a unit that area-irradiates the sample with an electron beam; and
a unit that scans the electron beam that area-irradiates the sample;
wherein said first X-ray lens has a zone plate that receives fluorescent X-rays from the sample that has been area-irradiated with the electron beam;
said detector senses an image that has been formed on said detector through said zone plate;
said decision unit determines pass/fail from the intensity of the fluorescent X-rays detected by said detector; and
said apparatus further comprises a unit that displays the image of the sample on a screen together with the location thereof if the sample has failed.

15. The apparatus according to claim 14, wherein the sample under inspection comprises a semiconductor device;
interconnection structure of the semiconductor device and the structure within an insulating film or the structure of the surface of the insulating film of said semiconductor device being displayed as images.

16. The apparatus according to claim 14, wherein said detector comprises multi-channel detectors which detect, as a line or plane, desired fluorescent X-rays from an area of the sample screen-irradiated by the electron beam;
said apparatus further comprising a plurality of A/D converters for converting detection signals from the multi-channel detectors to respective ones of parallel signals.

17. A confocal fluorescent X-ray microscope apparatus comprising:
a first lens to which are input fluorescent X-rays from a sample under inspection irradiated with an excitation beam;
a second lens disposed between the sample and an excitation-beam source which outputs the excitation beam; and
a pin hole disposed between said first lens and a detector;
wherein said first and second lenses construct a confocal optical system in which focal points of said lenses coincide;
said pin hole is placed at a confocal point, and the relationship between amount of generated fluorescent X-rays that are output from a spot at a focal-point position irradiated with the excitation beam and fluorescent X-ray intensity of fluorescent X-rays, from the irradiated spot, detected by said detector through said first lens and said pin hole is made essentially 1:1.

18. An inspection method using fluorescent X-rays, comprising:
detecting fluorescent X-rays from a sample under inspection, the fluorescent X-rays being detected by a detector through a zone plate; and
determining pass/fail of the sample based upon result of detection by the detector.

19. The method according to claim 18, further comprising:
area-irradiating the sample with an electron beam;
forming the image of desired fluorescent X-rays from an area of the sample area-irradiated with the electron beam on the detector through the zone plate and converting the fluorescent X-rays to an electric signal by the detector;
determining pass/fail of the sample from the electric signal; and
scanning the area area-irradiated with the electron beam and displaying an image of the sample obtained from the electric signal on a screen together with the location thereof in case of a fail.

20. The method according to claim 18, further comprising:
converging the X-rays through the zone plate and irradiating the sample; and
detecting desired fluorescent X-rays from the sample by the detector through the zone plate.
